(19) United States
(12) Patent Application Publication
(10) Pub. No.: US 2011/0232153 A1
(43) Pub. Date: Sep. 29, 2011

(54) MOVABLE TURKEY DECOY AND METHOD OF MAKING SAME

(76) Inventors: James E. Jennings, JR., Moberly, MO (US); Lance W. Stephens, Columbia, MO (US)

(21) Appl. No.: 13/072,199

(22) Filed: Mar. 25, 2011

Related U.S. Application Data
(60) Provisional application No. 61/318,069, filed on Mar. 26, 2010.

(51) Int. Cl. A01M 31/06; B23P 11/00

(52) U.S. Cl. 43/2; 29/428

(57) ABSTRACT

A method of assembling a turkey decoy includes coupling a head assembly and a tail assembly to a body using a head attachment mechanism and a tail attachment mechanism, respectively. The method also includes coupling a biasing device to each of the head and tail assemblies. The method further includes coupling a movement mechanism to the head assembly and the tail assembly for initiating movement of at least one of the head assembly and the tail assembly. A method for operating the turkey decoy includes positioning the turkey decoy in an outdoor field. The method also includes pulling the movement-applying string with sufficient tension to overcome a bias of the first force-applying device and modulating the position of the head assembly. The method further includes pulling the movement-applying string with sufficient tension to overcome a bias of the second force-applying device and modulating the position of the tail assembly.

### CROSS REFERENCE TO RELATED APPLICATIONS

This application claims the priority of Provisional Patent Application Ser. No. 61/318,069, entitled “A MOVABLE TURKEY DECOY AND METHOD OF MAKING THE SAME”, which was filed on Mar. 26, 2010 and which is hereby incorporated by reference in its entirety.

### BACKGROUND OF THE INVENTION

This invention relates generally to hunting decoys, and specifically to movable turkey decoys for attracting wild turkeys to a desired location and a method of making these decoys.

Many known turkey decoys are used to lure wild turkeys into a predetermined range for effective hunting, harvest, and/or observation and study. At least some of these known decoys are substantially stationary and provide a reasonable life-like appearance. Such stationary/static decoys represent the general shape, size, color, and feather pattern of a live turkey. Such static decoys are placed in an open area and used to attract a wild turkey, that may be passing by. These decoys are very basic and rely on the ability of a passing turkey to recognize the shape as a fellow turkey. However, wild turkeys are well known for their visual acuity in detecting slight movements, and a lack of movement may increase their suspicion of a static decoy.

Many known game animals, such as birds, and specifically wild turkeys, participate in courting rituals that are highly visual with the male of the species generally having vivid colorations and other displays to attract a female mate. For example, it is well-known among wild turkey hunters that during the turkey mating season, male turkeys (gobblers or toms) attempt to find female (hen) turkeys with which to breed. This results in gobblers initiating a mating ritual by spreading their tail feathers into a semi-circular fan shape and moving them from side-to-side in what is known as a full strut, to attract the hen to the gobbler for potential mating. Therefore, the male wild turkey is known for its spectacular display fan as it extends the plumage of its tail feathers during its courting ritual where it will strut about and ruffle its feathers in order to attract a receptive female. This particular behavior is known as strutting.

More specifically, during strutting, the tail feathers begin in a prone, or close to horizontal, position behind the bird and then rise vertically while simultaneously spreading into a fan shape. The strut demonstrates the dominance of the male turkey and thus convinces a female to mate with him. In general, the female turkey is attracted to the sight of the male turkey's fantail. A female wild turkey will indicate her receptiveness to breeding by assuming a submissive position in front of the male, a crouch position, with the neck erect and the head held perpendicular to the ground. In this regard, it is the hen that chooses the tom in response to the courting strut and display exhibited by the male.

Because of their competitive nature, other male turkeys are also attracted to the fantail display. The sight of a strutting male will excite and irritate a fellow male turkey. The males will compete for a hen by trying to out-strut their fellow male turkeys and/or by sparring. That is, the male turkey then will engage the competitors and attempt to drive them off or try to out-strut them. If a male turkey has already gathered a group of females it is very difficult to draw him away from their company. The sight of a competing male turkey that may steal his mates is one of the few things that will pull him away from his group of females.

Further, wild turkeys are also communal animals in which the hierarchy of the flock is established according to an established pecking order. In this regard, a tom's display fan may also serve as an indication of aggression as competing males attempt to establish their dominance within the flock. Once established, the pecking order particularly holds when it comes to breeding habits as discussed above, wherein the dominant male will aggressively suppress breeding activities of the subordinate toms within the flock.

Therefore, at least some known turkey decoys are moveable/motivated. Specifically, some decoys have been manufactured to partially simulate movement in a life-like fashion. More specifically, motion is employed to simulate/mimic movements of a live wild turkey in order to catch the attention of a passing or nearby turkey. However, some of these known movable decoys are static decoys positioned on a pivot point which uses wind to move the decoy side to side, or rock back and forth. Such wind-induced motion of the decoys is highly unpredictable and erratic, and does not realistically simulate actual wild turkey movements. Such use of random movement does not consistently give the level of certainty needed to attract a live turkey. Such movement may occur when the live turkey is out of sight or may occur too often when a turkey is close and frighten the turkey away. Moreover, other known movable decoys use a mechanism to simulate one movement of wild turkeys, but do not simulate other movements, and are therefore not sufficiently realistic.

### BRIEF DESCRIPTION OF THE INVENTION

In one aspect, a turkey decoy is provided. The turkey decoy includes a head assembly coupled to a body via a head attachment mechanism. The decoy also includes a tail assembly coupled to the body via a tail attachment mechanism. The decoy further includes at least one biasing device coupled to each of the head assembly and the tail assembly for applying a movement-resistant force thereon. The decoy also includes a movement mechanism coupled to each of said head assembly and said tail assembly for initiating movement of at least one of said head assembly and said tail assembly against the movement-resistant forces applied thereto.

In another aspect, a method of assembling a turkey decoy is provided. The method includes coupling a head assembly to a body using a head attachment mechanism. The method includes coupling a tail assembly to the body using a tail attachment mechanism. The method also includes coupling a biasing device to each of the head assembly and the tail assembly. The method further includes coupling a movement mechanism to each of the head assembly and the tail assembly for initiating movement of at least one of the head assembly and the tail assembly.

In another aspect, a method for operating a turkey decoy is provided. The method includes providing a turkey decoy that includes a body, a head assembly, a tail assembly, a first force-applying device, a second force-applying device, and a movement-applying string. The method also includes positioning the turkey decoy in an outdoor field. The method further includes pulling the movement-applying string with sufficient tension to overcome a bias of the first force-applying device and modulating the tension in the movement-applying string to modulate the head assembly between a fully upright position and a fully bowed position. The method also includes pulling the movement-applying string with sufficient tension to overcome a bias of the second force-applying device and modulating the tension in the movement-applying string to modulate the tail assembly between a fully upright position and a fully prone position.

### BRIEF DESCRIPTION OF THE DRAWINGS

FIG. 1 is a schematic exploded view of an exemplary partially assembled turkey decoy;

FIG. 2 is a schematic side view of the partially assembled turkey decoy shown in FIG. 1 in the field;

FIG. 3 is a schematic side view of the partially assembled turkey decoy shown in FIGS. 1 and 2 with a head assembly fully bowed and a tail assembly fully prone;

FIG. 4 is a side view of a comparison of the partially assembled turkey decoy shown in FIGS. 1 through 3 and an exemplary fully assembled taxidermied turkey decoy;

FIG. 5 is a perspective view of the fully assembled taxidermied turkey decoy shown in FIG. 4 with the head assembly and the tail assembly fully raised;

FIG. 6 is a side view of the fully assembled taxidermied turkey decoy shown in FIGS. 4 and 5 with the head assembly fully bowed and the tail assembly fully prone;

FIG. 7 is a schematic side view of an exemplary movable decoy stake system;

FIG. 8 is a schematic side view of an exemplary alternative turkey decoy that may be used with the movable decoy stake system shown in FIG. 7;

FIG. 9 is a schematic side view of another exemplary alterative turkey decoy and an exemplary alternative movable decoy stake system; and

FIG. 10 is a schematic overhead view an exemplary alternative head assembly that may be used with the turkey decoy shown in FIG. 9.

### DETAILED DESCRIPTION OF THE INVENTION

The effectiveness of a turkey decoy in attracting wild turkeys is limited by how closely the turkey decoy resembles a real turkey. More specifically, to be effective, a turkey decoy should look like a wild turkey and move like a wild turkey. The decoys and methods described herein include a decoy mechanism which emulates life-like movements of wild turkeys. Specifically, an operator initiates the motion of the decoys described herein with a manual pull string. Such manual activation capability as described gives the operator the advantage of triggering the decoy's movement at opportune times with motions closely simulating those of actual wild turkeys. More specifically, the manually motivated, taxidermied turkey decoy, as described herein, realistically simulates key behavioral aspects inherent to a gobbler's mating ritual. Also, a full strut may be used to not only attract hens, but also gobblers. Further, a hen's behavioral features may also be realistically simulated. Moreover, the decoy embodiments and methods described herein may be used to assemble and operate decoys of any wild bird.

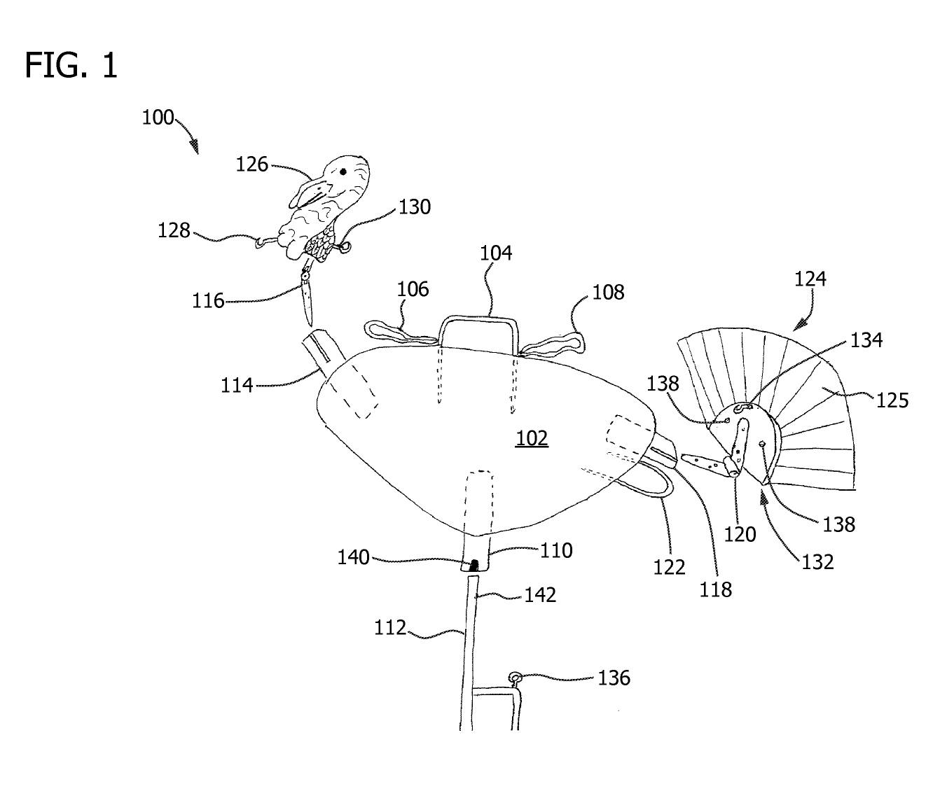

FIG. 1 is a schematic exploded view of an exemplary partially assembled turkey decoy 100. In the exemplary embodiment, turkey decoy 100 includes a body 102 manufactured from materials that include, without limitation, foam, plastic, and wood. Turkey decoy 100 also includes a handle 104 coupled to body 102 to facilitate transport of turkey decoy 100. Moreover, in the exemplary embodiment, handle 104 facilitates coupling of biasing, motive force-applying devices 106 and 108, hereon referred to as first and second biasing devices 106 and 108, respectively, and both discussed further below. Alternatively, such biasing devices 106 and 108 are coupled to any stationary attachment device that enables operation of turkey decoy 100 as described herein, including, without limitation, an eyebolt and a post.

Turkey decoy 100 further includes a tube 110, or cylinder 110, inserted into decoy body 102. Tube 110 is manufactured from materials that include, without limitation, foam, plastic, and wood. Such tube 110 facilitates placement of turkey decoy 100 onto a stake system, or ground stake 112 (discussed further below). Turkey decoy 100 also includes a first, or head receiving device 114 that receives a first, or turkey head attachment mechanism 116 (discussed further below). Turkey decoy 100 further includes a second, or tail receiving device 118 that receives a second, or tail attachment mechanism 120 (also discussed further below). In the exemplary embodiment, head receiving device 114 and tail receiving device 118 are tube, or cylindrical devices. In other embodiments, first and second receiving devices 114 and 118, respectively, are any devices that define a receiving cavity that enables assembly and operation of turkey decoy 100 as described herein.

Also, in the exemplary embodiment, turkey decoy 100 includes a tail stop device 122 that facilitates limiting arcual travel of a tail assembly 124 (discussed further below) to approximately 90°. Turkey decoy 100 also includes a turkey head assembly 126 that is manufactured by any method that enables operation of turkey decoy 100 as described herein, including, without limitation, epoxy cast molding. Moreover, head assembly 126 is manufactured of any material that enables operation of turkey decoy 100 as described herein, including, without limitation, rubber, foam, plastic, and wood. Turkey head assembly 126 includes turkey head attachment mechanism 116 fixedly coupled to head assembly 126. Attachment mechanism 116 is received by head receiving device 114, wherein mechanism 116 is any attachment device that applies a rotational/bending moment and enables motive operation of head assembly 126 as described herein, including, without limitation, hinges, springs, chain links, and linked eyebolts.

Further, in the exemplary embodiment, turkey head assembly 126 includes a string, or motive force-applying attachment device 128 coupled to head assembly 126, wherein device 128 is any device that guides a movement mechanism (not shown in FIG. 1), which includes, without limitation, an eyebolt and hook screw. The movement mechanism is any device, including, without limitation, string, cable, chain, or rope that enables operation of turkey decoy 100 as described herein. Turkey head assembly 126 also includes a biasing, or motive force-applying attachment device 130 coupled to head assembly 126, wherein device 130 is substantially similar to device 128.

Moreover, in the exemplary embodiment, turkey decoy 100 includes tail assembly 124 coupled to body 102. Tail assembly 124 includes a fan configuration. However, tail assembly 124 may include any configuration that enables operation of turkey decoy 100 as described herein. Tail assembly 124 may also include taxidermied real wild turkey feathers 125. Alternatively, tail assembly 124 includes any feather-like devices fabricated of any material that enables operation of the decoy as described herein. Tail assembly 124 further includes a tail assembly bracket 132, wherein the feathers are fixedly coupled. Bracket 132 is fabricated of any materials that enable operation of turkey decoy 100 as described herein, including, without limitation, wood, plastic, and metal. More specifically, bracket 132 is formed from two semicircular pieces (not shown) coupled to each other by methods that include, but are not limited to, fasteners and adhesives.

Tail assembly 124 also includes a biasing, or motive force-applying attachment device 134 that is substantially similar to devices 128 and 130. Tail assembly 124 further includes tail attachment mechanism 120 fixedly coupled to tail assembly 124, wherein mechanism 120 is substantially similar to mechanism 116.

Also, in the exemplary embodiment, turkey decoy 100 includes ground stake 112 that is received by tube 110. Stake 112 is fabricated of any materials that enable operation of turkey decoy 100 as described herein, including, without limitation, wood, plastic, and metal. Moreover, turkey decoy 100 also includes a string guide device 136 that receives the movement mechanism, e.g., motive string (not shown in FIG. 1). In the exemplary embodiment, string guide device 136 is any device that enables operation of turkey decoy 100 as described herein, including, without limitation, an eyebolt.

Further, in the exemplary embodiment, turkey decoy 100 includes biasing devices 106 and 108 coupled to handle 104 and motive force-applying attachment devices 130 and 134, respectively. Biasing devices 106 and 108 apply movement-resistant forces to head assembly 126 and tail assembly 124, respectively, and are any devices that enable operation of the decoy as described herein, including, without limitation, hydraulic pistons, bow-type devices, elastic bands, and springs.

Tail assembly 124 also includes fasteners 138 fixedly coupled to tail assembly 124, wherein fasters 138 facilitate fastening bracket 132 together and coupling feathers 125 to bracket 132. An optional notch 140 is defined in tube 110, and an optional anti-rotation device 142 is coupled to ground stake 112, wherein notch 140 and device 142 cooperate to facilitate establishing travel parameters for a predetermined radial motion of turkey decoy 100 during operation as described herein. Device 142 is any device that enables operation of the turkey decoy 100 including, but not limited to, a fastener, a post, and a dowel.

Motors, servos, and electronic processing devices may be used in some embodiments to at least partially automate turkey decoy 100 described herein.

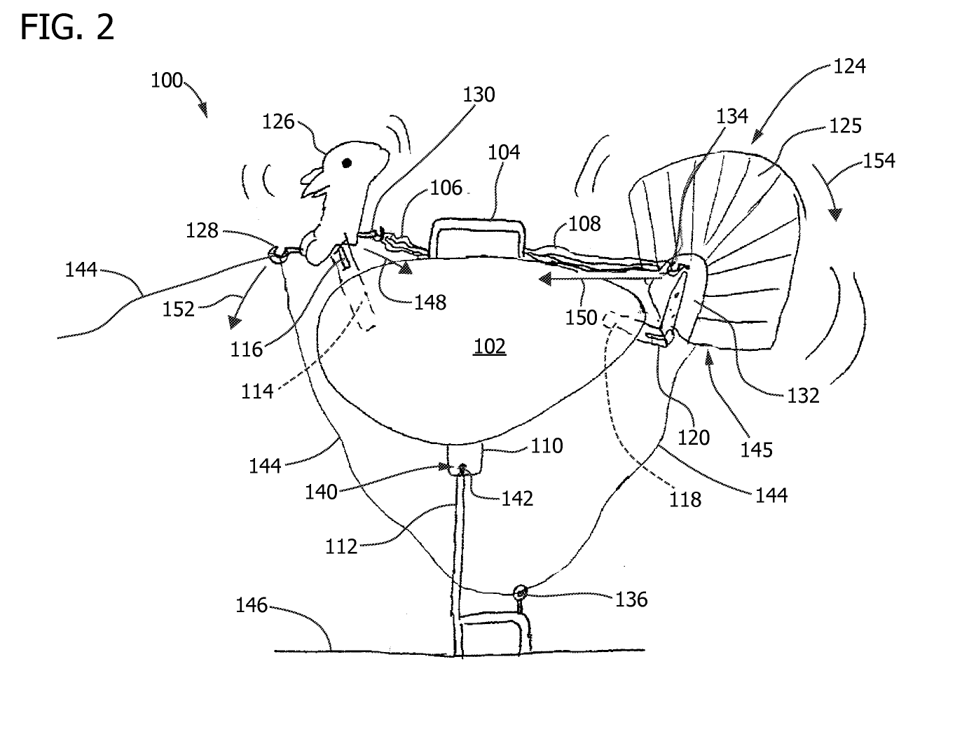

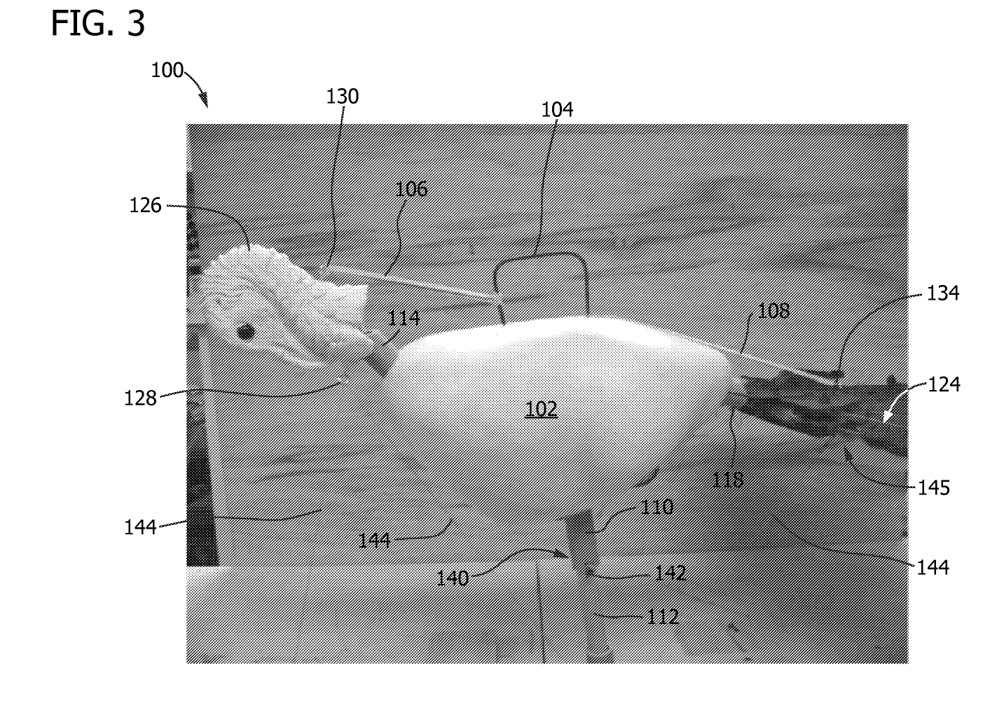

FIG. 2 is a schematic side view of partially assembled turkey decoy 100 in the field. Turkey decoy 100 includes a movement mechanism 144, e.g., motive string 144. Turkey decoy 100 also includes a string, or motive force-applying attachment device 145 coupled to tail assembly bracket 132 on the side opposite to motive force-applying attachment device 134. Attachment device 145 is configured to receive motive string 144 and is substantially similar to attachment devices 128, 130, and 134. FIG. 3 is a schematic side view of partially assembled turkey decoy 100 with head assembly 126 fully bowed and tail assembly 124 fully prone.

In operation, stake 112 is positioned into the ground 146. An operator (not shown) handling turkey decoy 100 positions decoy 100 onto stake 112 via handle 104, and slides tube 110 over stake 112. Head assembly 126 is coupled to body 102 by inserting attachment mechanism 116 into head receiving device 114, wherein head assembly 126 is oriented in a direction opposite to guide device 136. At least one biasing device 106 is coupled to handle 104 and motive force-applying attachment device 130, thereby applying a first movement-resistant force 148 on head assembly 126. Tail attachment 124 is coupled to body 102 by inserting attachment mechanism 120 into tail receiving device 118. At least one biasing device 108 is coupled to handle 104 and motive force-applying attachment device 134, thereby applying a second movement-resistant force 150 on tail assembly 124.

Also, in operation of the exemplary embodiment, at least one motive string 144 is channeled from a hunter area (not shown) through attachment device 128 and guide device 136, to attachment device 145. Motive string 144 is configured to apply a third force 152 to overcome first movement-resistant force 148 and initiate movement in head assembly 126. Motive string 144 is also configured to apply a fourth force 154 to overcome second movement-resistant force 150 and initiate movement in tail assembly 124. Fourth force 154 is greater than third force 152.

Further, in operation, the hunter pulls motive string 144, applying third force 152, and head assembly 126 shifts from the upright position to a bowed position in opposition to first biasing force 148 applied by biasing device 106. The hunter modulates the position of head assembly 126 between the fully upright position and the fully bowed position by modulating the tension on motive string 144. The hunter also shifts tail assembly 124 by further increasing and modulating the tension on motive string 144 by applying fourth force 154 in motive string 144 after head assembly 126 is fully bowed. Fourth force 154 is greater than third force 152. Therefore, tail assembly 124 is modulated between a fully upright position and a fully prone position in opposition to second biasing force 150 applied by biasing device 108. Head assembly 126 and tail assembly 124 are individually modulated based on the operator's experience and actual field conditions. Such independent actions include fluttering tail assembly 124 while maintaining head assembly 126 bowed. Such independent actions also include applying head assembly 126 to simulate gobbling, fluttering, and/or pecking with or without movement of tail assembly 124.

Moreover, in some alternative embodiments, the motive string 144 is coupled to tail assembly 124 first and then routed to head assembly 126 such that tail assembly 124 is moved prior to head assembly 126. Also, head assembly 126 and tail assembly 124 have any predetermined stationary initial positions defined along their associated arcual travel paths (not shown) that facilitate simulation of wild turkeys as described herein.

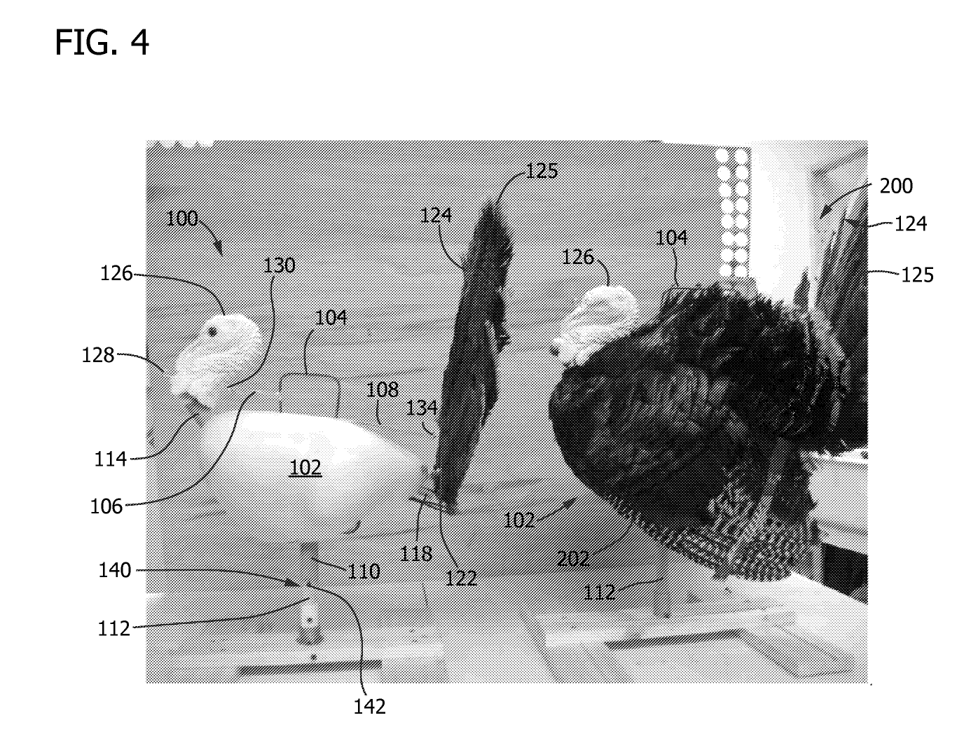

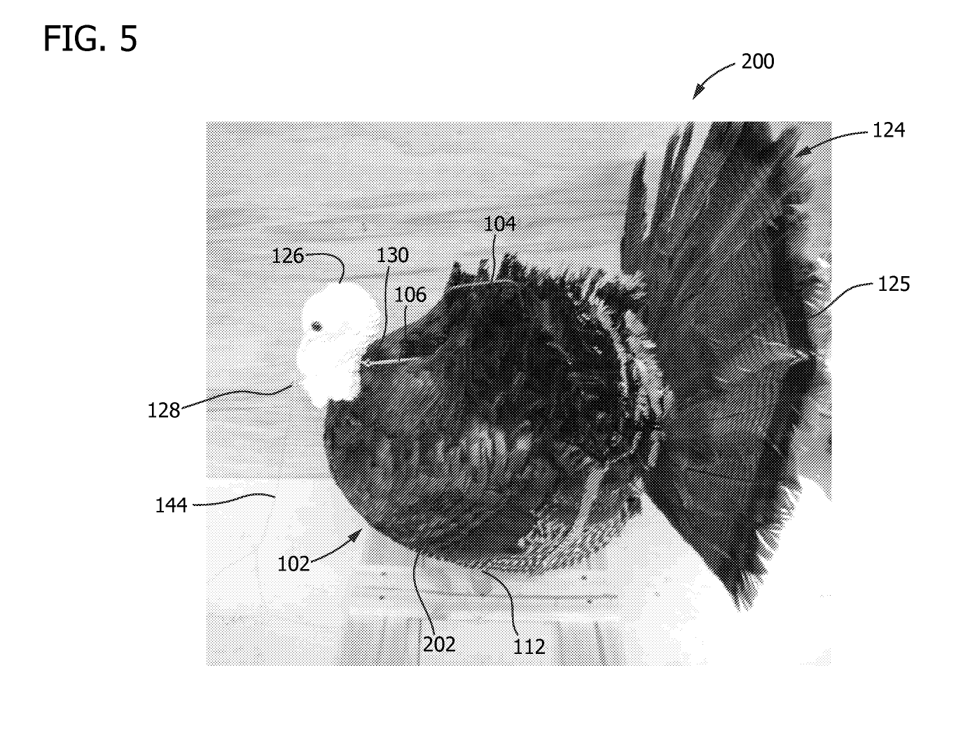

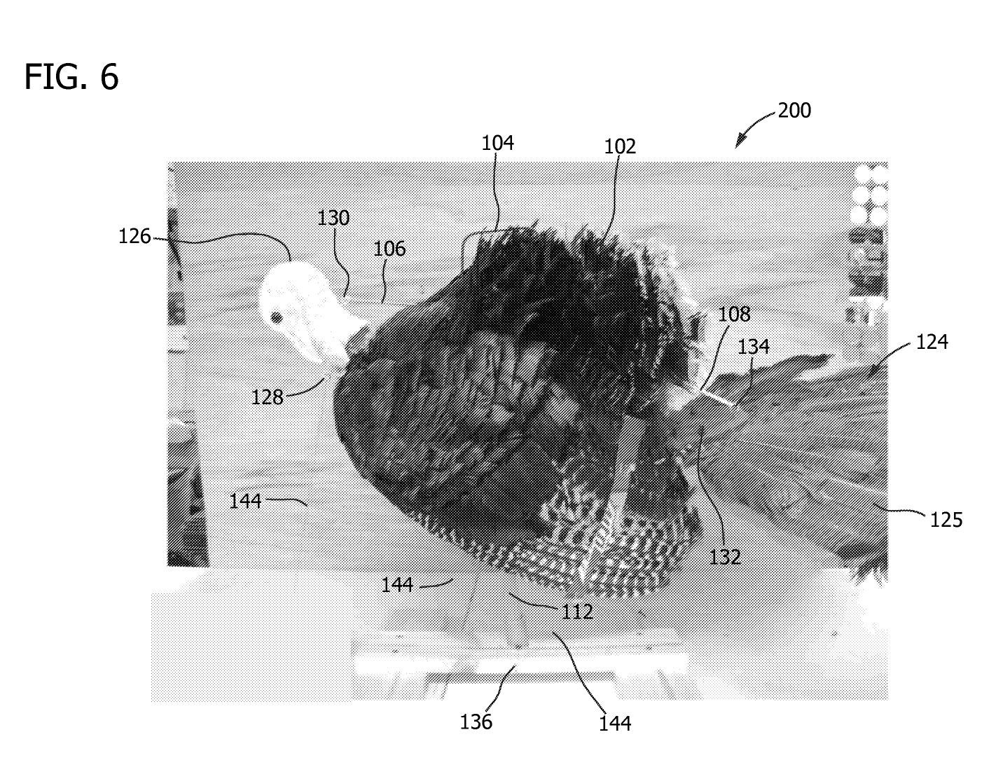

FIG. 4 is a side view of a comparison of partially assembled turkey decoy 100 and an exemplary fully assembled taxidermied turkey decoy 200. Turkey decoy 200 is similar to turkey decoy 100 with the exception that turkey decoy 200 includes a plurality of taxidermied feathers 202 coupled to body 102. FIG. 5 is a perspective view of fully assembled taxidermied turkey decoy 200 with head assembly 126 and tail assembly 124 fully raised. FIG. 6 is a side view of fully assembled taxidermied turkey decoy 200 shown with head assembly 126 fully bowed and tail assembly 124 fully prone. In the exemplary embodiment, a significant portion of turkey decoy 200 that includes devices not naturally occurring is hidden from view when head assembly 126 and tail assembly 124 are fully raised. Operation of turkey decoy 200 is substantially similar to that of turkey decoy 100.

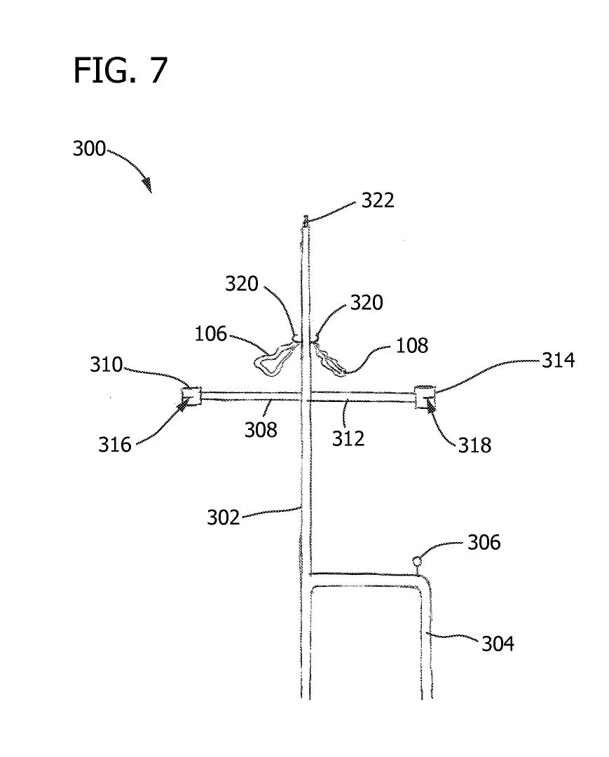

FIG. 7 is a schematic side view of an exemplary movable decoy stake system 300. In the exemplary embodiment, stake system 300 includes a ground stake 302 extending in a vertical direction for the entire vertical height of stake system 300. Stake system 300 also includes a stake extension 304 coupled to and extending from ground stake 302. Both ground stake 302 and stake extension 304 are configured to be inserted into the ground and to provide longitudinal stability for a turkey decoy (not shown in FIG. 7) positioned thereon. In the exemplary embodiment, ground stake 302 and stake extension 304 are fabricated unitarily of any materials that enable operation of stake system 300 as described herein, including, without limitation, wood, plastic, and metal. Alternatively, ground stake 302 and stake extension 304 may be fabricated separately and are coupled by any mechanism that enables operation of stake system 300 as described herein.

Stake system 300 also includes a string guide device 306 that receives a movement mechanism, e.g., motive string (not shown in FIG. 7). In the exemplary embodiment, string guide device 306 is substantially similar to string guide device 136 (shown in FIGS. 1 and 2), and is any device that enables operation of stake system 300 as described herein, including, without limitation, an eyebolt.

Stake system 300 further includes a head support member 308 coupled to and extending from ground stake 302. Head support member 308 includes a front, or head assembly receptacle 310 that receives a head assembly (not shown in FIG. 7). Stake system 300 also includes a tail support member 312 coupled to and extending from ground stake 302. Tail support member 312 includes a rear, or tail assembly receptacle 314 that receives a tail assembly (not shown in FIG. 7). In the exemplary embodiment, head assembly receptacle 310 and tail assembly receptacle 314 are tubes, or cylindrical devices, each with a slit 316 and 318, respectively, defined thereon. Slits 316 and 318 facilitate receipt of head and tail attachment devices (neither shown in FIG. 7), respectively. In other embodiments, head and tail assembly receptacles 310 and 314 may be any devices that define a receiving cavity that enables assembly and operation of stake system 300 and any turkey decoy as described herein.

In the exemplary embodiment, head support member 308 and tail support member 312 extend from ground stake 302 substantially horizontally. Alternatively, head support member 308 and tail support member 312 extend from ground stake 302 in any direction and any orientation that enables operation of stake system 300 as described herein. Moreover, in the exemplary embodiment, head support member 308, head assembly receptacle 310, tail support member 312, and tail assembly receptacle 314 are fabricated from polyvinylchloride (PVC) piping. Alternatively, members 308 and 312 and receptacles 310 and 314 may be fabricated from any materials that enable operation of stake system 300 as described herein. Furthermore, in the exemplary embodiment, head assembly receptacle 310 may be tail assembly receptacle 314 are configured to receive and coupled to the head assembly and the tail assembly, respectively, by a friction fit. Alternatively, mechanical fastening hardware may be used.

Stake system 300 further includes at least one string, or motive force-applying attachment device 320 coupled to ground stake 302, wherein each device 320 is any device that enables operation of stake system 300, including, without limitation, an eyebolt and hook screw that guides a movement mechanism (not shown in FIG. 7). The movement mechanism (not shown in FIG. 7) is any device that enables operation of stake system 300, including, without limitation, string, cable, chain, or rope. Motive force-applying attachment device 320 is substantially similar to motive force-applying attachment devices 128, 130, and 134 (all shown in FIGS. 1, 2, and 6).

Stake system 300 also includes a handle attachment device 322 positioned at the top of ground stake 302. Handle attachment device 322 includes any mechanical fastening apparatus that enables operation of stake system 300 as described herein, including, without limitation, a nut and bolt.

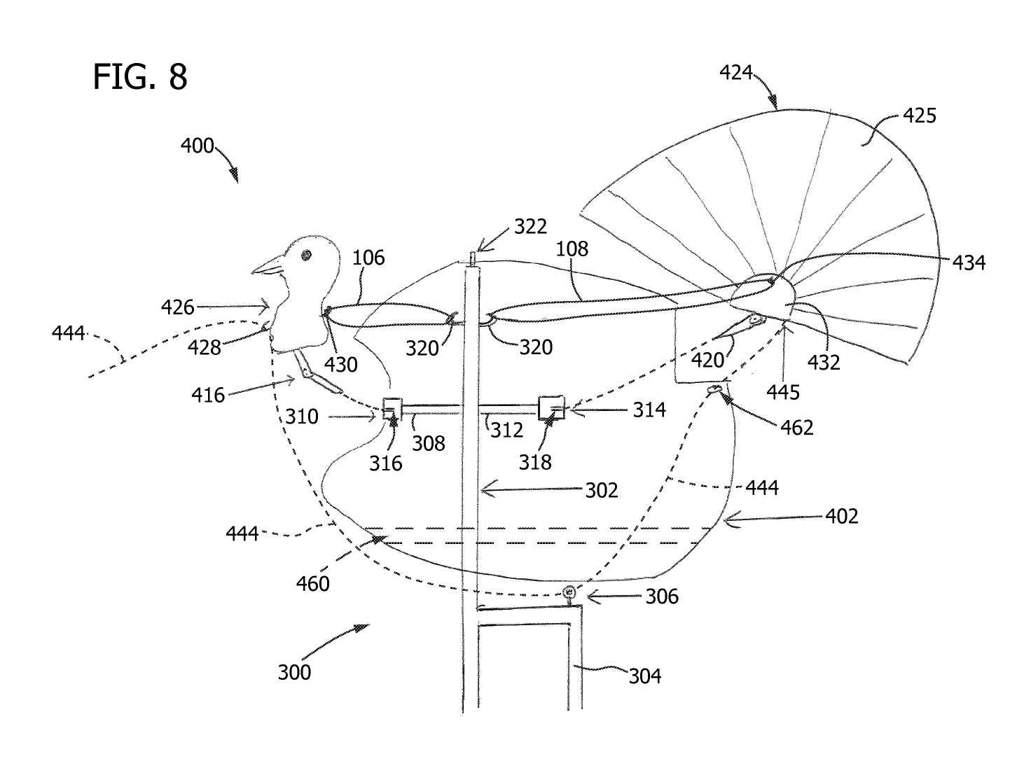

FIG. 8 is a schematic side view of an exemplary alternative turkey decoy 400 that may be used with movable decoy stake system 300. Turkey decoy 400 includes an artificial body 402 configured to receive most of stake system 300 above string guide device 306. Artificial body 402 is fabricated from any material that enables operation of turkey decoy 400 as described herein, including, without limitation, molded plastic.

Turkey decoy 400 also includes a head assembly 426 that includes a head attachment mechanism 416 fixedly coupled to head assembly 426. Head assembly receptacle 310 receives attachment mechanism 416, wherein mechanism 416 is any attachment device that applies a rotational/bending moment and enables motive operation of head assembly 426 as described herein, including, without limitation, hinges, springs, chain links, and linked eyebolts.

Head assembly 426 includes a string, or motive force-applying attachment device 428 coupled to head assembly 426, wherein device 428 is any device that guides a movement mechanism 444, including, without limitation, an eyebolt and hook screw. Movement mechanism 444 is any device that enables operation of turkey decoy 400 as described herein, including, without limitation, string, cable, chain, and rope. Head assembly 426 also includes a biasing, or motive force-applying attachment device 430 coupled to head assembly 426, wherein device 430 is substantially similar to device 428. First biasing device 106 is coupled to and extends between motive force-applying attachment devices 320 and 430.

Turkey decoy 400 further includes a tail assembly 424 that includes a tail attachment mechanism 420 fixedly coupled to tail assembly 424, wherein mechanism 420 is substantially similar to mechanism 416. Tail assembly 424 also includes taxidermied real wild turkey feathers 425. Alternatively, tail assembly 424 may include any feather-like devices fabricated of any material that enables operation of the decoy as described herein. Tail assembly 424 further includes a tail assembly bracket 432, wherein the feathers are fixedly coupled. Bracket 432 is fabricated of any materials that enable operation of turkey decoy 400 as described herein, including, without limitation, wood, plastic, and metal. More specifically, bracket 432 is formed from two semicircular pieces (not shown) coupled to each other by methods that include, but are not limited to, fasteners and adhesives.

Tail assembly 424 also includes a biasing, or motive force-applying attachment device 434 that is substantially similar to devices 428 and 430. Second biasing device 108 is coupled to and extends between motive force-applying attachment devices 320 and 434. Tail assembly 424 further also includes a string, or motive force-applying attachment device 445 coupled to tail assembly bracket 432 on a side opposite to motive force-applying attachment device 434.

In some embodiments, turkey decoy 400 also includes a plurality of optional clips 460 coupled to body 402 (only some shown in FIG. 8). Clips 460 facilitate coupling of taxidermied feathers (not shown in FIG. 8) to body 402.

Turkey decoy 400 includes an opening 462 defined within body 402 adjacent to tail assembly receptacle 314 and tail assembly 424. Opening 462 is configured to receive movement mechanism 444, e.g., string for initiating movement in body 402 as it is routed between string guide device 306 and attachment device 445. Such movement of body 402 is characterized by a slight turning movement about ground stake 302 that appears natural to nearby live turkeys. Such movement is further characterized by apparent floating and shaking as a function of the tension in movement mechanism 444 that also appears natural to nearby live turkeys. Otherwise, operation of turkey decoy 400 is similar to that for turkey decoy 100 (shown in FIGS. 1 through 3).

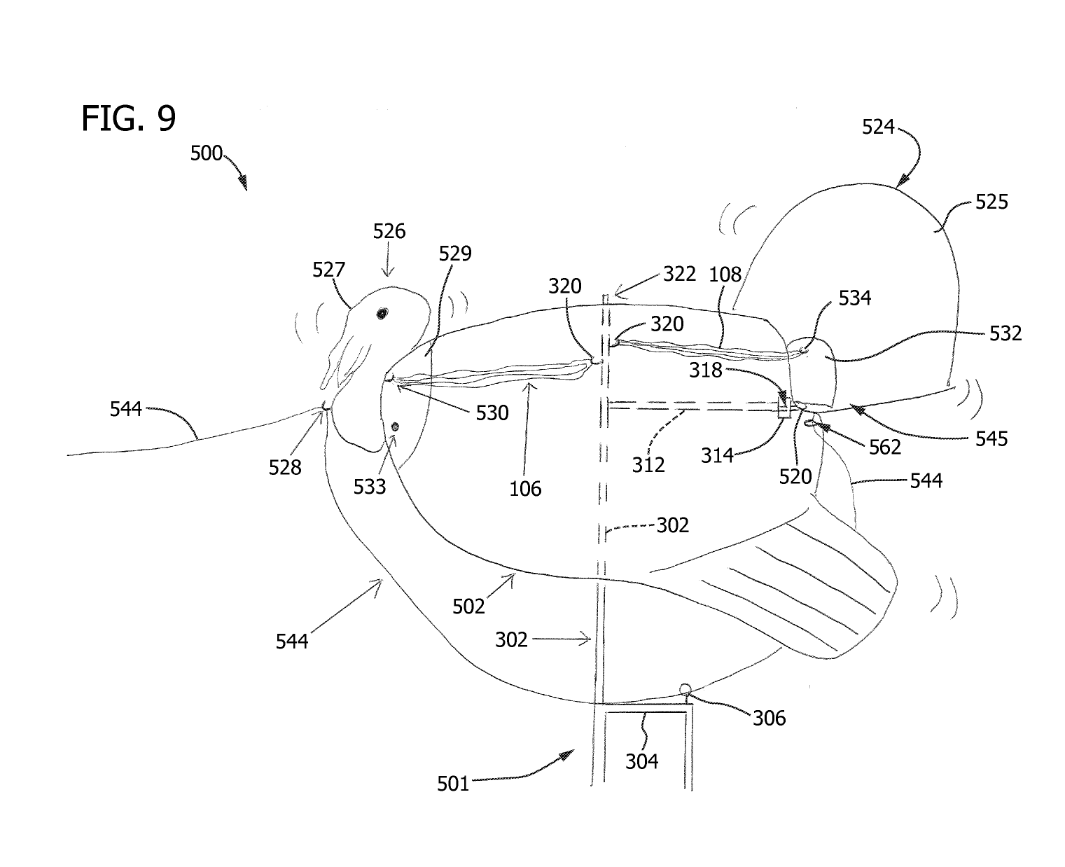

FIG. 9 is a schematic side view of another exemplary alterative turkey decoy 500 and an exemplary alternative movable decoy stake system 501. Stake system 501 is similar to stake system 300 (shown in FIGS. 7 and 8) with the exception that stake system 501 does not include a head support member 308 and associated head assembly receptacle 310 and slit 316 (all shown in FIGS. 7 and 8). Moreover, alternative embodiments of stake system 501 may not have tail support member 312, rear assembly receptacle 314, and slit 318.

Turkey decoy 500 includes an artificial body 502 that is configured to receive a portion of stake system 501 above string guide device 306. Artificial body 502 is fabricated from any material that enables operation of turkey decoy 400 as described herein, including, without limitation, molded plastic and rubber. In this alternative embodiment, artificial body 502 is a realistic facsimile of a turkey body. Artificial body 502 includes a first side 503 and a second side 505.

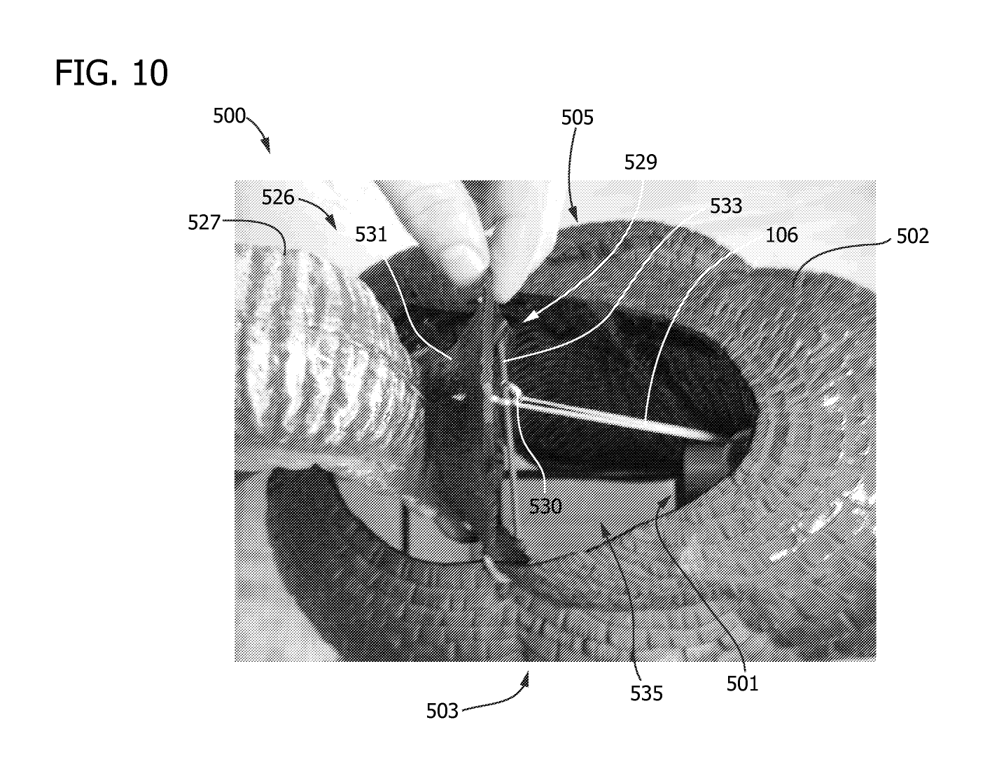

FIG. 10 is a schematic overhead view an exemplary alternative head assembly 526 that may be used with the turkey decoy 500. In this alternative embodiment, turkey decoy 500 also includes head assembly 526, which includes a turkey head 527 unitarily formed with a swivel device 529. Swivel device 529 includes an upper portion 531 of body 502. Swivel device 529 also includes a transverse member 533 coupled to upper portion 531 and extending between first side 503 and second side 505 of body 502. Transverse member 533 is rotationally coupled to first side 503 and second side 505 of body 502. Head assembly 526 also includes a biasing, or motive force-applying attachment device 530 coupled to upper portion 531, wherein device 530 is any device that receives biasing device 106, including, without limitation, an eyebolt and hook screw. When head assembly 526 is tilted forward, an access opening 535 is defined in the top of body 502 to allow access to attachment device 530 and biasing device. Moreover, alternative embodiments of turkey decoy 500 may includes a swivel device (not shown) for tail assembly 524 that is similar to swivel device 529.

Referring again to FIG. 9, head assembly 526 includes a string, or motive force-applying attachment device 528 coupled to head assembly 526, wherein device 528 is any device that guides a movement mechanism 544, including, without limitation, an eyebolt and hook screw. Device 528 is substantially similar to device 530. Movement mechanism 544 is any device that enables operation of turkey decoy 500 as described herein, including, without limitation, string, cable, chain, and rope.

Turkey decoy 500 further includes a tail assembly 524 that includes a tail attachment mechanism 520 fixedly coupled to tail assembly 524, wherein mechanism 520 is substantially similar to mechanism 420 (shown in FIG. 8). Tail assembly 524 also includes taxidermied real wild turkey feathers 525. Alternatively, tail assembly 524 may include any feather-like devices fabricated of any material that enables operation of the decoy as described herein. Tail assembly 524 further includes a tail assembly bracket 532, wherein the feathers are fixedly coupled. Bracket 532 is fabricated of any materials that enable operation of turkey decoy 500 as described herein, including, without limitation, wood, plastic, and metal. More specifically, bracket 532 is formed from two semicircular pieces (not shown) that are coupled to each other by methods that include, but are not limited to, fasteners and adhesives.

Tail assembly 524 also includes a biasing, or motive force-applying attachment device 534 that is substantially similar to devices 528 and 530. Second biasing device 108 is coupled to and extends between motive force-applying attachment devices 520 and 534. Tail assembly 524 further also includes a string, or motive force-applying attachment device 545 coupled to tail assembly bracket 532 on a side opposite to motive force-applying attachment device 534.

Turkey decoy 500 includes an opening 562 defined within body 502 adjacent to tail assembly receptacle 314 and tail assembly 524. Opening 562 is configured to receive movement mechanism 544, e.g., string for initiating movement in body 502, as it is routed between string guide device 306 and attachment device 545. Such movement of body 502 is characterized by a slight turning movement about ground stake 302 that appears natural to nearby live turkeys. Such movement is further characterized by apparent floating and shaking as a function of the tension in movement mechanism 544 that also appears natural to nearby live turkeys. Operation of turkey decoy 500 is similar to that for turkey decoy 400 (shown in FIG. 8) with the exception of operation of head assembly 526, swivel device 529, and transverse member 533 in place of head assembly 428.

Methods and apparatus for using a turkey decoy to facilitate attracting wild turkeys are provided herein. Specifically, a turkey decoy is fabricated to closely resemble a wild turkey. Moreover, the turkey decoy is assembled to move in a manner similar to a wild turkey. More specifically, the decoys and methods described herein include a decoy mechanism which emulates life-like movements of wild turkeys. The motion of the decoys described herein is initiated by an operator with a manual pull string. Such manual activation capability as described gives the operator the advantage of triggering the decoy's movement at opportune times with motions closely simulating those of actual wild turkeys. Such manually motivated, taxidermied turkey decoys realistically simulate key behavioral aspects inherent to a gobbler's mating ritual. Also, a full strut may be used to not only attract hens, but also gobblers. Further, a hen's behavioral features may also be realistically simulated. Moreover, the decoy embodiments and methods described herein may be used to assemble and operate decoys of any wild bird.

Exemplary embodiments of turkey decoys as associated with attracting wild turkeys are described above in detail. The methods, apparatus and systems are not limited to the specific embodiments described herein nor to the specific illustrated turkey decoys.

While the invention has been described in terms of various specific embodiments, those skilled in the art will recognize that the invention can be practiced with modification within the spirit and scope of the claims.

What is claimed is:

1. A turkey decoy comprising:
a head assembly coupled to a body using a head attachment mechanism;
a tail assembly coupled to said body using a tail attachment mechanism;
at least one biasing device coupled to each of said head assembly and said tail assembly for applying a movement-resistant force thereon; and
a movement mechanism coupled to each of said head assembly and said tail assembly for initiating movement of at least one of said head assembly and said tail assembly against the movement-resistant forces applied thereto.

2. A turkey decoy in accordance with claim 1 wherein said at least one biasing device comprises:
a first biasing device for applying a first force to said head assembly; and
a second biasing device for applying a second force to said tail assembly,
wherein said movement mechanism is configured to:
apply a third force to overcome the first force and initiate movement in said head assembly; and
apply a fourth force to overcome the second force and initiate movement in said tail assembly,
wherein the fourth force is greater than the third force.

3. A turkey decoy in accordance with claim 1 further comprising a tail assembly receptacle configured to receive said tail attachment mechanism, wherein said body defines an opening adjacent to said tail assembly receptacle, said opening configured to receive said movement mechanism for initiating movement in said body.

4. A turkey decoy in accordance with claim 1 further comprising a stake system, said stake system comprising:
a ground stake comprising a guide device configured to receive said movement mechanism for facilitating movement of said tail assembly; and
an anti-rotation device.

5. A turkey decoy in accordance with claim 1 further comprising a stake system, said stake system comprising
a tail assembly receptacle configured to receive said tail attachment mechanism; and
a ground stake comprising a guide device configured to receive said movement mechanism for facilitating movement of said tail assembly.

6. A turkey decoy in accordance with claim 1 further comprising a stake system, said stake system comprising
a head assembly receptacle configured to receive said head attachment mechanism;
a tail assembly receptacle configured to receive said tail attachment mechanism; and
a ground stake comprising a guide device configured to receive said movement mechanism for facilitating movement of said tail assembly.

7. A turkey decoy in accordance with claim 1 further comprising a stake system, said stake system comprising at least one of:
at least one attachment apparatus configured to receive said at least one biasing device; and
at least one vertical member coupled to at least a portion of said body, said at least one vertical member is coupled to a handle.

8. A turkey decoy in accordance with claim 1 wherein said head assembly comprises a turkey head unitarily formed with a swivel device, said swivel device comprises at least one transverse member rotatably coupled to each of a first side of said body and a second side of said body and extending therebetween.

9. A turkey decoy in accordance with claim 8 wherein said swivel device is coupled to said at least one biasing device for said head assembly.

10. A method of assembling a turkey decoy, said method comprising:
coupling a head assembly to a body using a head attachment mechanism;
coupling a tail assembly to the body using a tail attachment mechanism;
coupling a biasing device to each of the head assembly and the tail assembly; and
coupling a movement mechanism to at least one of the head assembly and the tail assembly, thereby configuring the movement mechanism to initiate movement of at least one of the head assembly and the tail assembly.

11. A method in accordance with claim 10 wherein coupling a biasing device to each of the head assembly and the tail assembly comprises
coupling a first biasing device for applying a first force to the head assembly; and
coupling a second biasing device for applying a second force to the tail assembly.

12. A method in accordance with claim 11 wherein coupling a movement mechanism to each of the head assembly and the tail assembly comprises:
configuring the movement mechanism to apply a third force to overcome the first force and initiate movement in the head assembly; and
configuring the movement mechanism to apply a fourth force to overcome the second force and initiate movement in the tail assembly,
wherein the fourth force is greater than the third force.

13. A method in accordance with claim 10 further comprising:
coupling the tail attachment mechanism to a tail assembly receptacle positioned within the body;
defining an opening within the body adjacent to the tail assembly receptacle; and
inserting a portion of the movement mechanism through the opening to facilitate initiating movement in the body.

14. A method in accordance with claim 10 further comprising:
providing a stake system;
coupling the head attachment mechanism to a head assembly receptacle positioned within the body; and
coupling the tail attachment mechanism to a tail assembly receptacle positioned within the body.

15. A method in accordance with claim 10 further comprising:
providing a stake system that includes a guide device; and
inserting a portion of the movement mechanism through the guide device to facilitate initiating movement of the tail assembly.

16. A method in accordance with claim 10 further comprising:
providing a stake system that includes at least one attachment apparatus; and
coupling the at least one biasing device to the at least one attachment apparatus.

17. A method in accordance with claim 10 further comprising:
providing a stake system that includes at least one vertical member coupled to at least a portion of the body; and
coupling the at least one vertical member to at least one of:
a head support member that includes a head assembly receptacle;
a tail support member that includes a tail assembly receptacle; and
a handle.

18. A method in accordance with claim 10 wherein coupling a head assembly to a body using a head attachment mechanism comprises:
forming a turkey head unitarily with a swivel device that includes at least one transverse member rotatably coupled to each of a first side of the body and a second side of the body and extending therebetween; and
coupling the swivel device to the at least one biasing device for the head assembly.

19. A method for operating a turkey decoy, said method comprising:
providing a turkey decoy that includes a body, a head assembly, a tail assembly, a first force-applying device, a second force-applying device, and a movement-applying string;
positioning the turkey decoy in an outdoor field;
pulling the movement-applying string with sufficient tension to overcome a bias of the first force-applying device;
modulating the tension in the movement-applying string to modulate the head assembly between a fully upright position and a fully bowed position;
pulling the movement-applying string with sufficient tension to overcome a bias of the second force-applying device; and
modulating the tension in the movement-applying string to modulate the tail assembly between a fully upright position and a fully prone position.

20. A method in accordance with claim 19 further comprising:
threading at least a portion of the movement-applying string through an opening formed within the body adjacent to the tail assembly; and
pulling the movement-applying string with sufficient tension to initiate movement in the body.
